(19) United States
(12) Patent Application Publication
(10) Pub. No.: US 2020/0191189 A1
(43) Pub. Date: Jun. 18, 2020

(54) SELF-LOCKING PIN

(71) Applicant: MR INDUSTRIAL FASTENERS S.r.l., Treviolo (Bergamo) (IT)

(72) Inventor: Alessandro CASSOTTI, Treviolo (Bergamo) (IT)

(21) Appl. No.: 16/628,714

(22) PCT Filed: Jul. 10, 2018
(86) PCT No.: PCT/IB2018/055057

§ 371 Date: Jan. 6, 2020

(30) Foreign Application Priority Data
Jul. 10, 2017 (IT) 102017000077402

(51) Int. Cl. F16B 21/12

(52) U.S. Cl. CPC F16B 21/125

(57) ABSTRACT

A self-locking pin comprising a pin body, a movable body slidably housed in the pin body in a form-fitting manner, the movable body being subjected to an axial force exerted by a first elastic element and having an end portion protruding from the pin body. The movable body has a radial detent seat wherein a locking detent is slidably housed, pushed radially outwards through a radial hole made in the pin body by a second elastic element housed in the detent seat. The radial locking detent has a distal detent portion which engages with play the radial hole and a proximal detent portion, which is larger in diameter than the distal detent portion, which engages with play the detent seat.

The present invention concerns a self-locking pin for connecting at least two side-by-side elements wherein respective through holes are made, aligned with each other.

Typically, the side-by-side elements to be connected are perforated sheet metal elements, such as uprights, brackets and feet, for example, to make shelves.

The most commonly used connecting elements are screws and nuts. However, this connection system suffers from certain drawbacks. The screw holes are often made in positions not easily accessible, and tightening/loosening the nut on the opposite side of the screw insertion side is an even more inconvenient operation, which is also why the nut may not be correctly screwed in.

Moreover, if the structure to be assembled is subjected to vibrations, the nut may loosen, affecting the stability of the structure.

To remedy these drawbacks, self-locking pins have been proposed, i.e. pins which, after the pin has been inserted into the aligned holes of the elements to be connected, do not require the application of a separate element to perform the locking function.

An example of such self-locking pins is described in U.S. Pat. No. 6,872,039. The pin is provided with a locking detent inserted in a radial seat obtained in the body of the pin and pressed towards the outside by a spring. The detent ends with a wedge-shaped head turned in such a way that, during insertion into the aligned holes of the structures to be assembled, the detent retracts at the level of the pin body and then emerges again automatically, pushed by the spring, when it has passed through the hole.

This embodiment is, however, impractical when the structures to be connected are internally hollow, for example in the case of bent or extruded sheet metal uprights. In effect, when the locking detent, in the advanced position, is inside the structure, it is not possible to access it in order to keep it pressed so as to allow the pin to be completely removed from such structure.

In an attempt to solve this drawback, U.S. Pat. No. 6,782,039 proposes a variant embodiment wherein the detent, once pressed, may be rotated, for example, with a screwdriver and is configured in such a way that, once rotated, it remains axially locked in its seat.

However, even this variant embodiment requires the end of the pin to be accessible for handling the locking detent.

Other known embodiments of the self-locking pin have a complex structure and lead to high production costs.

The object of the present invention is to propose a self-locking pin able to remedy the aforementioned drawbacks of the self-locking pins cited above and which at the same time has a simple structure, consisting of a reduced number of components, and therefore is reliable and economical to produce.

Said object is achieved with a self-locking pin according to claim 1. The dependent claims describe preferred embodiments of the invention.

The features and advantages of the self-locking pin according to the invention will, however, become evident from the description provided hereinafter of their preferred embodiments, given by way of indicative and non-limiting examples, with reference to the accompanying figures, wherein:

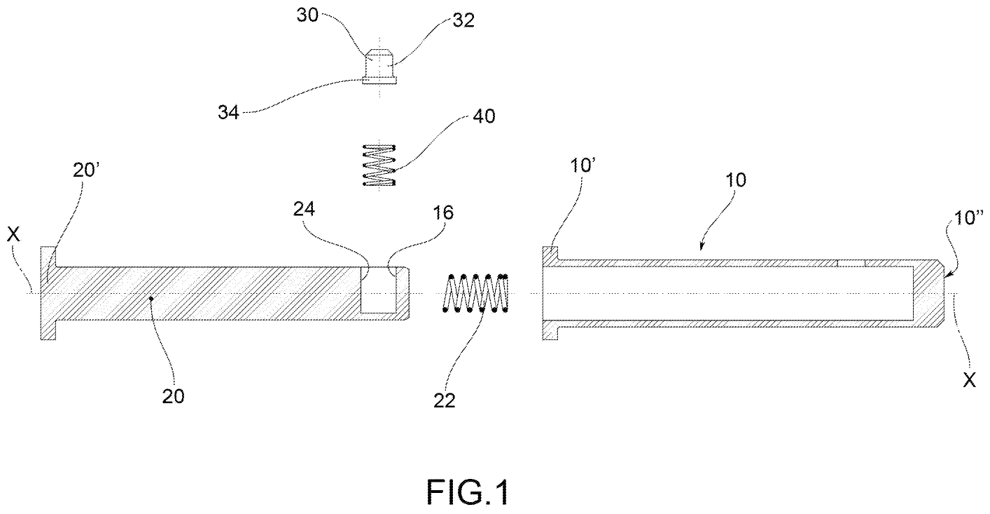

FIG. 1 is an exploded, sectional view of the self-locking pin according to the invention, in a first embodiment;

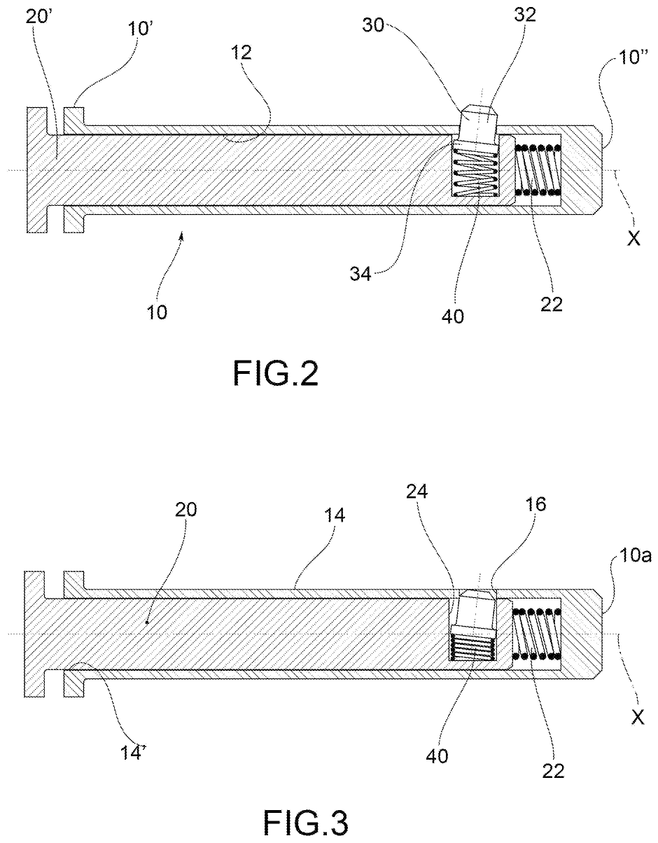

FIG. 2 is an axial section of the self-locking pin of FIG. 1 assembled and with the locking detent in the advanced locked position;

FIG. 3 is an axial section of the self-locking pin in FIG. 1, with the detent in a retracted unlocked position;

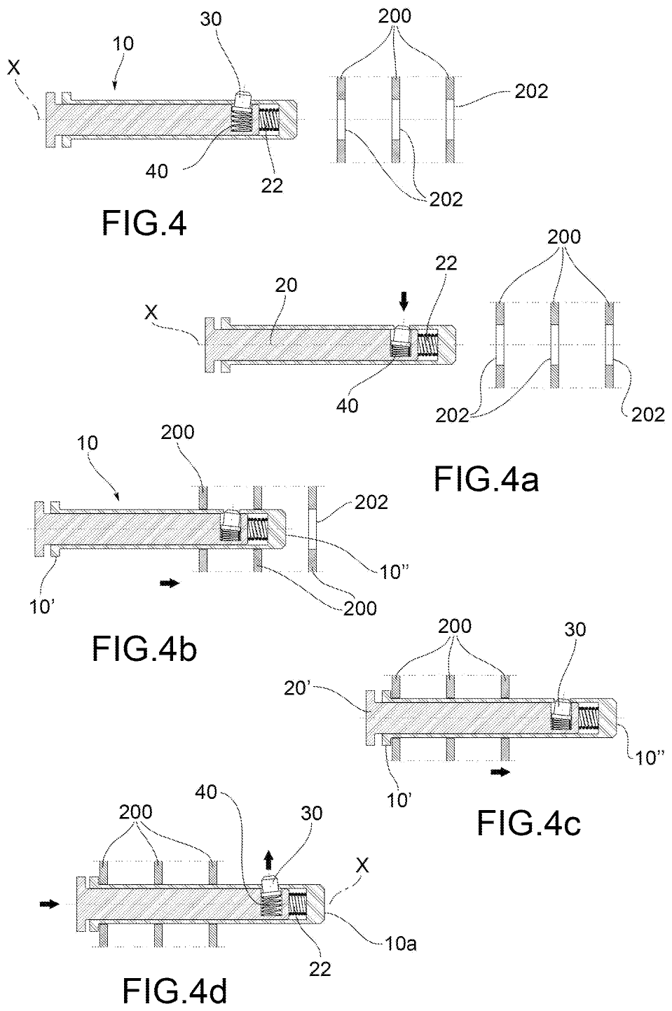

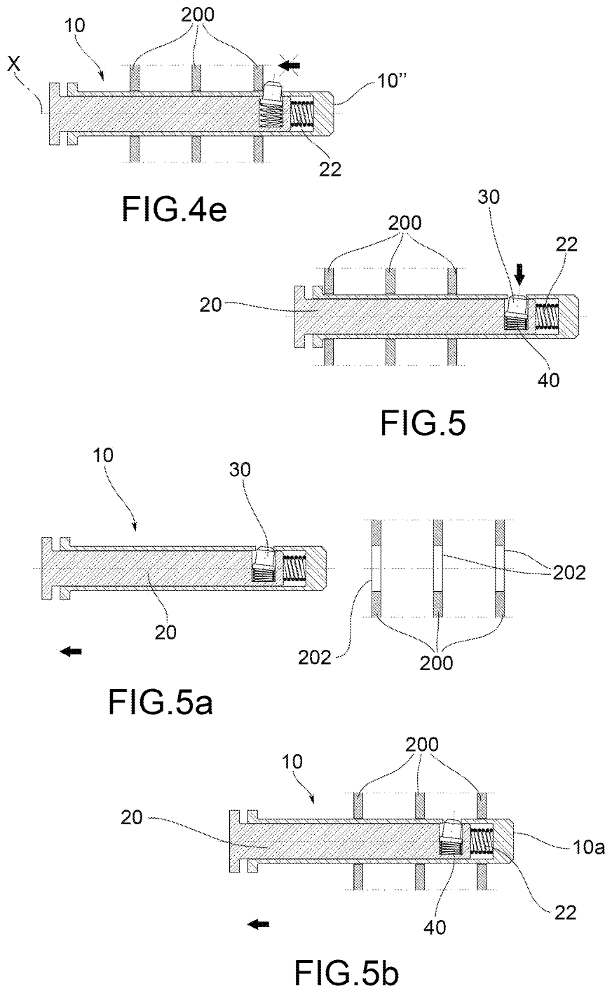

FIGS. 4-4eillustrate, in axial section, the steps of an operation of connecting elements by means of the self-locking pin of the preceding figures;

FIGS. 5-5b illustrate, in axial section, the steps of an operation of extracting the self-locking pin from the previously connected elements;

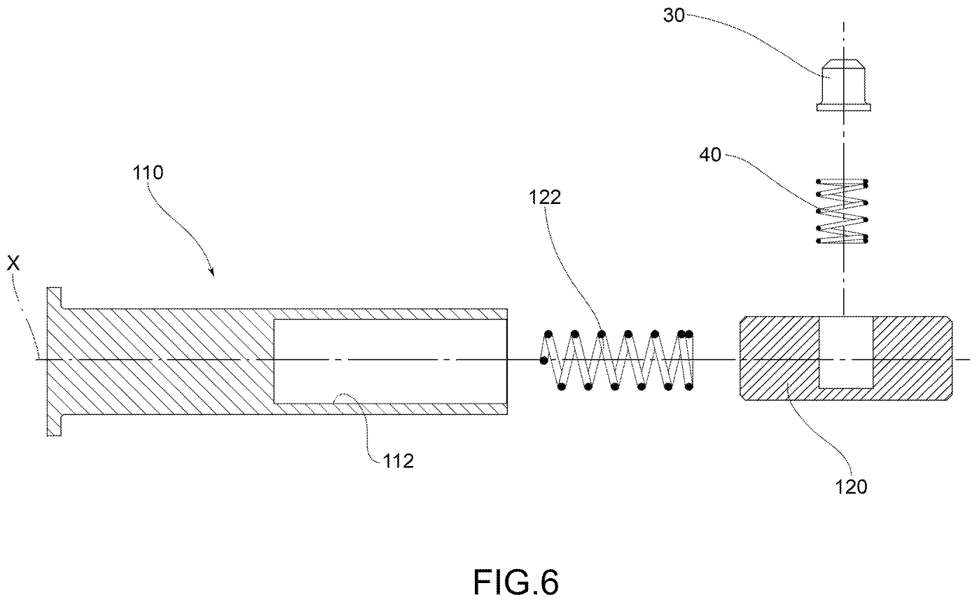

FIG. 6 is an exploded, sectional view of the self-locking pin according to the invention, in a second embodiment;

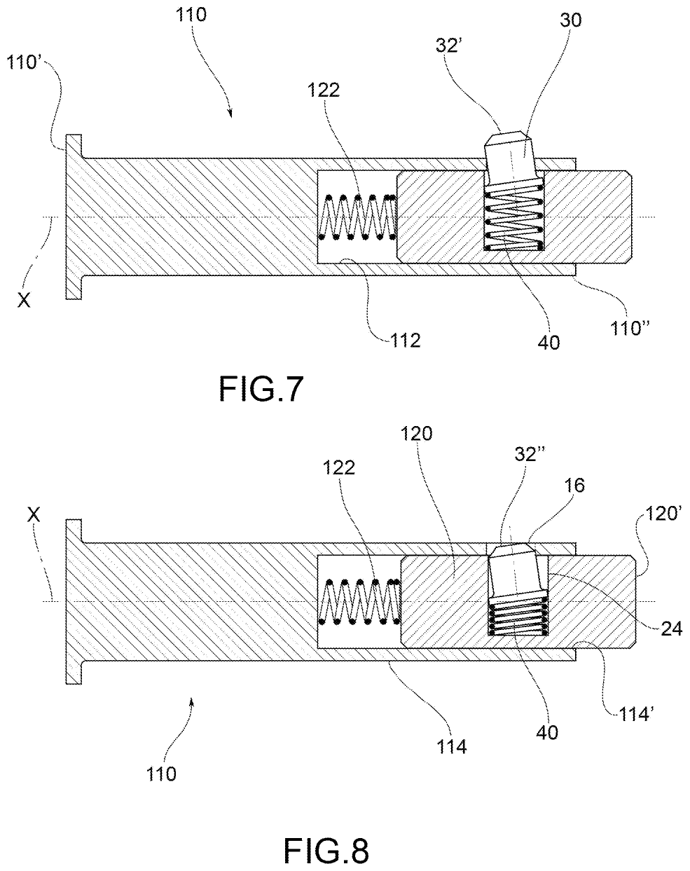

FIG. 7 is an axial section of the self-locking pin of FIG. 6 assembled and with the locking detent in the advanced locked position;

FIG. 8 is an axial section of the self-locking pin in FIG. 6, with the detent in a retracted unlocked position;

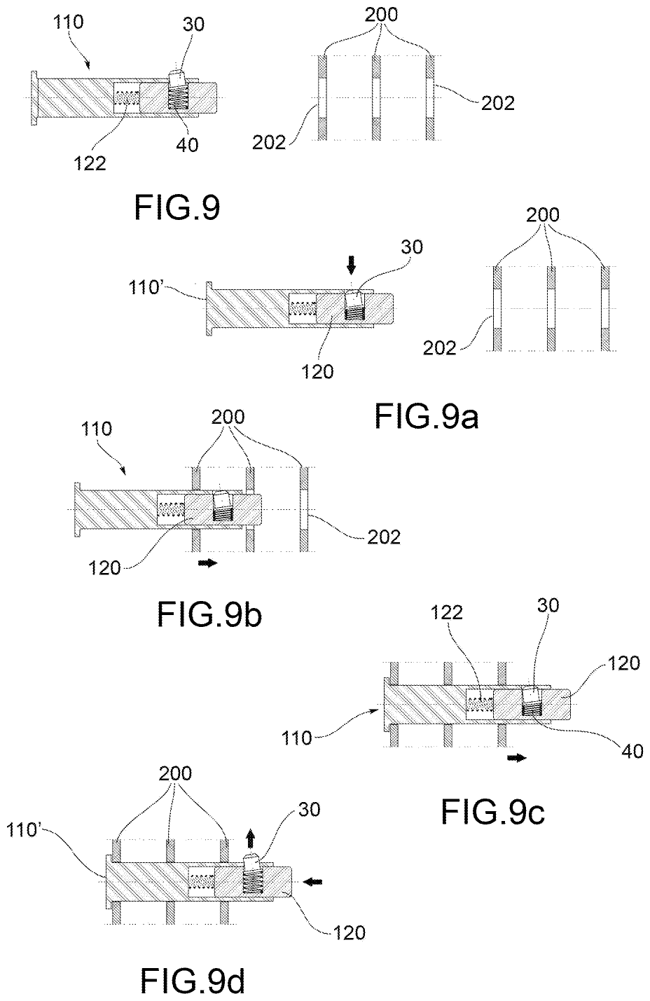

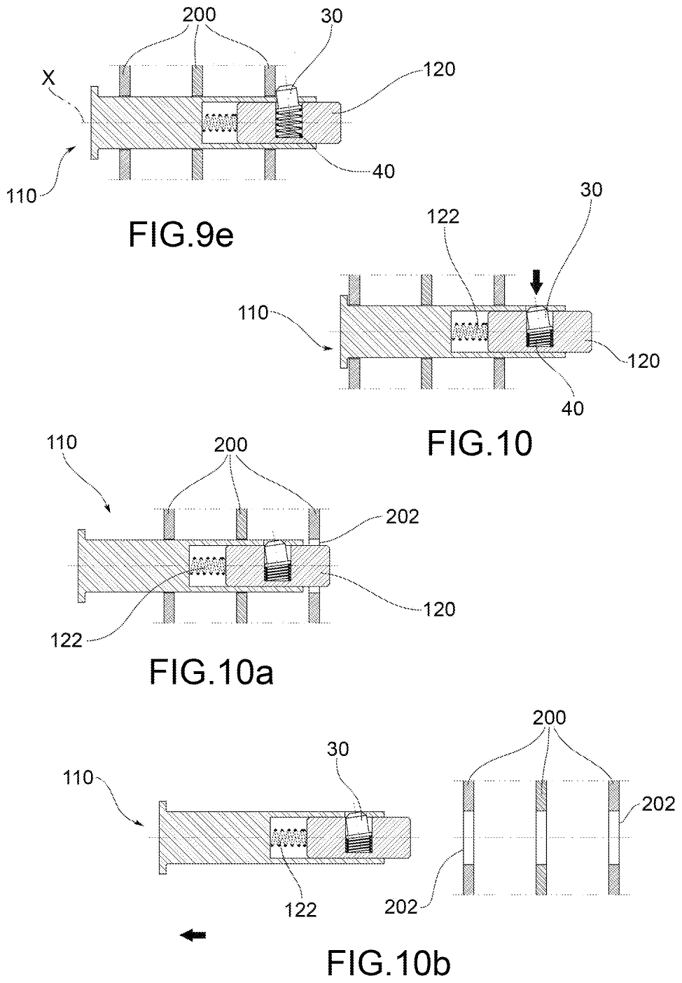

FIGS. 9-9e illustrate, in axial section, the steps of an operation of connecting elements by means of the self-locking pin of FIG. 6; and

FIGS. 10-10b illustrate, in axial section, the steps of an operation of extracting the self-locking pin of FIG. 6 from the previously connected elements.

In said drawings, a self-locking pin according to the invention has been indicated collectively at 1; 100.

In the following description, elements common to the various embodiments represented in the drawings of the invention are indicated at the same numeric references.

In a general embodiment, the pin 1; 100 comprises a pin body 10; 110 extending around a pin axis X between a proximal end 10′; 110′ and a distal end 10″; 110″. In the context of the present application, “proximal end” means the end of the pin that is held by the operator during the operations of insertion and extraction in the structure to be assembled; the distal end, opposite the proximal end, is therefore the end of the pin body that is inserted into the structure.

For example, the pin body 10; 110 has a cylindrical shape.

In one embodiment, the proximal end 10′; 110′ forms a gripping flange 11.

In at least one distal portion of the pin body 10; 110, a chamber 12; 112 is obtained. Such chamber 12; 112 is delimited by a side wall portion 14, 114 of the pin body 10; 110. In other words, in at least one distal portion thereof, the pin body 10; 110 is a hollow body, i.e. it has a tubular structure.

The chamber 12; 112 has a chamber end 12′; 112′ open to the outside at either the proximal end 10′; 110′ or the distal end 10″; 110″ of the pin body 10, 110.

A radial hole 16, e.g. a circular one, is made in the side wall portion 14, 114.

The pin 1; 100 further comprises a movable body 20; 120 slidably housed with form fitting in the chamber 12; 112.

This movable body 20, 120 is subjected to an axial force exerted by a first elastic element 22 and directed towards the open chamber end 12′; 112′.

For example, the first elastic element 22 is housed in the chamber 12; 112, between a back wall 12″; 112″ of this and a movable body end 20; 120.

For example, the first spring element 22 is a cylindrical helical spring.

The movable body 20; 120 has an end portion 20′; 120′ protruding from the open chamber end 12′; 112′ (and therefore protruding also from the pin body 10; 110).

Therefore, the movable body 20; 120 is accessible from the outside of the pin body 10, 110 to be pressed, like a button, by an operator in the direction opposite to the direction of thrust of the first elastic element 22.

In the movable body 20; 120 a radial detent seat 24 is made, open towards the radial hole 16 and having a diameter greater than the diameter of the radial hole 16.

A locking detent 30 is slidably housed in this radial detent seat 24. A second elastic element 40, which tends to push the locking pin 30 outwards radially, is moreover housed in the radial detent seat 24.

The locking detent 30 has a distal detent portion 32 which engages with play the radial hole 16 and a proximal detent portion 34, which is larger in diameter than the distal detent portion 32, which engages with play the radial detent seat 24.

In the context of the present description, the expression “engage with play” is used to define a dimensional relationship between the distal detent portion 32 and the diameter of the radial hole 16, and between the proximal detent portion 34 and the diameter of the radial detent seat 24, whereby the detent is not axially guided by either the radial hole 16 or the radial detent seat 24, but is free to position itself with some inclination with respect to the radial direction orthogonal to the pin axis X, as shown in the figures.

The locking detent 30 is movable radially between an advanced locked position (FIGS. 2 and 6), where the distal portion 32 protrudes from the side wall portion 14; 114 of the pin body 10; 110, and a retracted unlocked position (FIGS. 3 and 7), wherein the distal end of the locking detent 30 is flush with the side wall portion 14; 114.

It should be noted that, due to the inclination of the locking detent 30 with respect to the radial direction, when the locking detent 30 is in the advanced position, the distal portion 32 thereof is engaged by the outer and inner edges of the lateral surface delimiting the radial hole 16. Due to such interaction between the distal portion 32 and the edges of the radial hole 16, the locking detent 30 remains locked in such advanced position.

Moreover, again by virtue of the slope of the locking detent 30, when the locking detent 30 is in the retracted position, the “distal end of the detent flush with the side wall portion of the pin body” means that the apex of the most radially protruding locking detent is flush with such portion of the side wall. In this position, a point on the distal end of the detent opposite such apex is engaged by the lateral surface of the radial hole.

Therefore, as a result of the play between the distal detent portion 32 and the radial hole 16, when the locking detent 30 is pressed into the retracted position, the movable body 20; 120 is free to move slightly toward the open chamber end 12′; 112′, causing an additional, albeit minimal, rotation of the locking detent 30 with respect to the radial direction until, following such translation, the distal end 30 of the detent is inserted in the lateral surface that delimits the radial hole 16. In this way, a new position of equilibrium is reached wherein the locking detent 30 is again locked by the lateral surface of the radial hole and prevents further translation of the movable body 20; 120.

Therefore, as may be seen from FIGS. 3 and 7, once pressed into the retracted position, the detent may be released without it returning to the advanced position.

To return the locking detent 30 to the advanced locked position, it is sufficient to apply pressure to the movable element 20; 120 in the opposite direction to that in which the elastic element acts so as to cause a translation of the movable element 20; 120 in such opposite direction. As a result of such translation, the radial detent seat 24 tends to align with the radial hole 16, thus causing a slight rotation of the locking detent in the radial direction, which in turn causes the disengagement of the distal end of the detent from the lateral surface delimiting the radial hole 16 and therefore the translation of the detent into the locked position.

In one embodiment, the distal detent portion 32 is provided with an end chamfer 32′ at the distal end to facilitate the return of the locking detent 30 to the advanced locked position. In other words, such end chamfer 32′ serves as a guide for sliding the distal detent portion 32 along the lateral surface of the radial hole 16, so as to prevent the locking detent 30 from jamming.

In one embodiment, the distal detent portion 32 has a cylindrical shape ending with a flat head 32″. The flat head 32″ extends orthogonally to the axis of the cylindrical distal portion. In this way, the locking detent 30 is simple to make and assemble to the pin as it is axial-symmetric. In addition, a slight slope with respect to the radial direction is sufficient to “sink” the locking detent completely in the profile of the pin body.

In one embodiment, the chamber 12; 112 and the movable body 20; 120 have a cylindrical shape and are coaxial to the pin axis X.

In one embodiment illustrated in FIGS. 1-5b, the chamber 12 is open at the proximal end 10′ of the pin body 10 and extends axially to the distal end 10″ of the pin body 10. In this case, the distal end 10″ of the pin body 10 is delimited by a distal wall 10a.

In the variant embodiment illustrated in FIGS. 6-10b, the chamber 112 is open at the distal end 110″ of the pin body 110.

For example, the chamber 112 extends from the distal end 110″ of the pin body 110 to approximately half of the axial extension of the pin body 110.

FIGS. 4-3e and 9-9e illustrate steps for the use of a self-locking pin 1; 100 for the connection of two adjacent elements represented in the example by three parallel walls 200, each penetrated by a wall hole 202. The three wall holes 202 are aligned with each other.

FIGS. 4 and 9 show the self-locking pin 1; 100 in a starting position, wherein the locking detent 30 is in the advanced locked position.

In FIGS. 4a and 9a, the locking detent 30 is pressed into the retracted position. Once pressed, the locking detent 30 remains in the retracted position even after releasing the pressure thereon.

At this point, the self-locking pin 1; 100 may be passed through the wall holes 202 (FIGS. 4b and 9b).

The distal portion of the self-locking pin 1; 100 bearing the locking detent 30 is made to protrude from the last wall 200 (FIGS. 4c and 9c).

At this point, the operator acts on the movable body 20; 120, pressing it axially so as to cause, as explained above, the locking detent 30 to emerge from the pin body 10; 110 (FIGS. 4d and 9d).

The pin is then pulled backwards to send the locking detent 30 in abutment against the inner wall (FIGS. 4e and 9e).

In order to extract the pin 1; 100 from the previously connected elements, the locking detent 30 is simply pressed into the retracted position (FIGS. 5 and 10). It is not necessary to use tools and it is not necessary to perform any other handling of the detent. As explained above, the detent remains in the retracted position.

At this point, the pin may be retracted by passing through the wall holes 202 with the locking detent 30 sunk inside the pin (FIGS. 5a and 10a).

FIGS. 5b and 10b show the pin 1; 100 fully extracted, with the locking detent 30 still in the retracted position.

To the embodiments of the self-locking pin according to the invention, a person skilled in the art may, to satisfy contingent needs, make modifications, adaptations and replacements of elements with others that are functionally equivalent, without departing from the scope of the following claims. Each of the features described as belonging to a possible embodiment may be implemented independently from the other described embodiments.

1. A self-locking pin for connecting at least two side-by-side elements wherein respective through holes are aligned, the self-locking pin comprising:
a pin body extending around a pin axis (X) between a proximal end and a distal end, a chamber delimited by a side wall portion of the pin body being obtained in at least one distal portion of said pin body, said chamber having a chamber end open towards the outside at one of said proximal end or distal end of the pin body, a radial hole being made in said side wall portion;
a movable body housed slidably housed in said chamber in a form-fitting manner, said movable body being subjected to an axial force exerted by a first elastic element and directed towards said chamber end and having an end portion protruding from said chamber end, a radial detent seat being formed in said movable body open towards the radial hole and having a greater diameter greater than a diameter of the radial hole, a locking detent being slidably housed in the detent seat and pushed radially towards the outside by a second elastic element housed in the detent seat, the radial locking detent having a distal detent portion engaging with play the radial hole and a proximal detent portion with a greater diameter than the distal detent portion, engaging the detent seat with play, the radial locking detent being radially movable between an advanced locked position, wherein the distal detent portion protrudes from the side wall portion of the pin body, and a retracted unlocked position, wherein the distal end of the locking detent is flush with said side wall portion and wherein, by effect of said play between the distal detent portion and the radial hole, the movable body is free to move toward the chamber end causing a radial locking of the locking detent by fitting tightly between its distal end and an edge delimiting the radial hole.

2. The self-locking pin of claim 1, wherein the distal detent portion has a chamfer at its distal end to facilitate the return of the locking detent to the advanced locked position.

3. The self-locking pin of claim 1, wherein the distal detent portion has a cylindrical shape ending with a flat head.

4. The self-locking pin of claim 1, wherein the first elastic element is a spring, including a cylindrical helical spring.

5. The self-locking pin of claim 1, wherein the second elastic element is a spring, including a cylindrical helical spring.

6. The self-locking pin of claim 1, wherein the chamber and the movable body are cylindrical and coaxial to the pin axis.

7. The self-locking pin of claim 1, wherein the pin body is cylindrical.

8. The self-locking pin of claim 1, wherein the chamber is open at the proximal end of the pin body and extends axially to near the distal end of the pin body, said distal end of the pin body being delimited by a distal wall.

9. The self-locking pin of claim 1, wherein the chamber is open at the distal end of the pin body.

10. The self-locking pin of claim 9, wherein the chamber extends from the distal end of the pin body to approximately half the axial extension of the pin body.
